(19) United States
(12) Patent Application Publication
(10) Pub. No.: US 2026/0339362 A1
(43) Pub. Date: Oct. 29, 2026

(54) INTEGRATED PURIFIED WATER SUPPLY SYSTEM AND CONTROL METHOD THEREFOR

(71) Applicant: LG ELECTRONICS INC., Seoul (KR)

(72) Inventors: Myoung Hoon LEE, Seoul (KR); Jongwoo PARK, Seoul (KR); Ho Seon CHOI, Seoul (KR)

(21) Appl. No.: 19/124,347

(22) PCT Filed: Mar. 27, 2023
(86) PCT No.: PCT/KR2023/004029

§ 371 Date: Apr. 25, 2025

(30) Foreign Application Priority Data
Nov. 2, 2022 (KR) 10-2022-0144228

(51) Int. Cl. G05D 7/06; C02F 1/00; C02F 1/46; G05B 15/02

(52) U.S. Cl. CPC G05D 7/0623; C02F 1/001; C02F 1/4608; G05B 15/02; C02F 2201/005; C02F 2209/40; C02F 2209/44

(57) ABSTRACT

Disclosed are an integrated purified water supply system and a control method therefor, the system being capable of supplying a sufficient amount of purified water to a plurality of home appliances that use water. The system comprises: an integrated water purifier for purifying raw water; a first supply valve and a second supply valve for supplying water purified by the integrated water purifier to a first home appliance and a second home appliance; and a controller which controls communication with the first home appliance and the second home appliance, and controls the operation of the integrated water purifier. When a water selection for the first home appliance is input, the controller determines whether the second home appliance uses water, and when the second home appliance is using water, the controller determines the priorities of the first home appliance and the second home appliance.

### TECHNICAL FIELD

The present invention relates to an integrated purified water supply system, and more specifically, to an integrated purified water supply system and a control method therefor, which are capable of supplying a sufficient amount of purified water to a plurality of water-using home appliances.

### BACKGROUND ART

A water purifier is a device that filters raw water supplied from an external source and provides drinking water to users. To this end, the water purifier includes at least one filter for filtering the raw water, a plurality of pipings through which the raw water or the purified water flows, a valve for controlling the flow of the raw water or the purified water, and the like.

Recently, there is a growing need to develop an integrated purified water supply device to supply purified water from a single water supply line to various home appliances which use water.

Patent Document 1 (Republic of Korea Patent No. 10-0343674) proposes a multipurpose water supply device that stores tap water which is too polluted to be used as drinking water in a storage tank so that it can be used for other purposes instead of discarding it.

In Patent Document 1, tap water supplied from a faucet passes through a contamination level measurement device and a filter, and then is supplied to a water supply valve assembly, which, if the measured value by the contamination level measurement device is equal to or less than a reference value, supplies the water to a water tank or an ice maker or of a refrigerator, or if the measured value is greater than the reference value, supplies the water to a dishwasher or a washing machine.

However, Patent Document 1 has a problem in that, when a home appliance uses water while another home appliance is using water, it cannot supply a sufficient amount of purified water to the home appliances.

### DISCLOSURE

### Technical Problem

The technical problem to be solved by the present invention is to provide an integrated purified water supply system and a control method therefor, which are capable of supplying a sufficient amount of purified water to a plurality of water-using home appliances.

Additionally, it is to provide an integrated purified water supply system and a control method therefor, which are capable of supplying a sufficient amount of purified water by controlling at least one or more of standby operation, pause, and simultaneous operation depending on whether another home appliance is used, and on the order of priority.

Additionally, it is to provide an integrated purified water supply system and a control method thereof, which are capable of supplying a sufficient amount of purified water required by each home appliance by controlling at least one or more of the respective supply valves of the home appliances and pump operation.

The purposes of the present invention are not limited to the purposes mentioned above, and other purposes and advantages of the present invention which are not mentioned can be appreciated from the following description, and will be more clearly appreciated by the embodiments of the present invention. Furthermore, it is readily understood that the objects and advantages of the present invention can be achieved by the means set forth in the claims and combinations thereof.

### Technical Solution

An integrated purified water supply system according to an embodiment supplies a sufficient amount of purified water to a plurality of water-using home appliances.

Specifically, when a water selection for a first home appliance is entered, it determines whether a second home appliance is using water, and determines the order of priority between the first home appliance and the second home appliance in the case where the second home appliance is using water.

Additionally, when the water selection for the home appliance is entered, an integrated purified water supply system according to an embodiment controls at least one or more of standby operation, pause, and simultaneous operation depending on whether another home appliance is used, and on the order of priority.

Specifically, it controls at least one of a feed valve, a first supply valve, and a second supply valve so that purified water is supplied to at least one of the first home appliance and the second home appliance according to the order of priority.

Additionally, an integrated purified water supply system according to an embodiment supplies a sufficient amount of purified water required by each home appliance by controlling at least one or more of the respective supply valves of the home appliances and the pump operation.

Specifically, it controls at least one of the standby operation of at least one of the first home appliance and the second home appliance, the pump operation, a turning-on operation of a feed valve, and a turning-on operation of at least one of the first supply valve and the second supply valve according to the order of priority.

An integrated purified water supply system according to an embodiment includes an integrated water purifier purifying raw water, a first supply valve and a second supply valve, both the supply valves allowing water purified by the integrated water purifier to be supplied to a first home appliance and a second home appliance, and a controller controlling communication with the first home appliance and the second home appliance, and controlling an operation of the integrated water purifier, and determines whether a second home appliance is using water when a water selection for a first home appliance is entered, and determines the order of priority between the first home appliance and the second home appliance in the case where the second home appliance is using water.

A control method for an integrated purified water supply system according to an embodiment of the present invention, the system including an integrated water purifier purifying raw water, a first supply valve and a second supply valve, both the supply valves allowing the water purified by the integrated water purifier to be supplied to the first home appliance and the second home appliance, and a controller controlling communication with the first home appliance and the second home appliance, and controlling an operation of the integrated water purifier, includes determining whether the second home appliance is using water, when a water selection for the first home appliance is entered, and determining an order of priority between the first home appliance and the second home appliance in a case where the second home appliance is using water.

### Advantageous Effects

The integrated purified water supply system and the control method therefor according to an embodiment can supply a sufficient amount of purified water to a plurality of water-using home appliances.

Additionally, by controlling at least one of the standby operation, pause, and simultaneous operation depending on whether another home appliance is used, and on the order of priority, a sufficient amount of purified water can be supplied to each home appliance.

Additionally, by controlling at least one or more of the respective supply valves of the home appliances and the pump operation, a sufficient amount of purified water required by each home appliance can be supplied.

Additionally, through a single integrated water purifier, it is possible to provide a stable supply of purified water to all water-using home appliances.

Additionally, it is possible to supply purified water efficiently to each home appliance according to the set separate order of priority.

Additionally, it is possible to supply purified water at an output water amount required by each home appliance.

Additionally, it is possible to increase consumer convenience and satisfaction by controlling a single integrated water purifier according to the order of priority to efficiently supply a sufficient amount of purified water to other home appliances which use water at the same time.

In addition to the effects described above, specific effects of the present invention will be described below together with specific matters for practicing the invention.

### DESCRIPTION OF DRAWINGS

FIG. 1 is a conceptual diagram of an integrated purified water supply system according to an embodiment.

FIG. 2 is a structural diagram of an integrated purified water supply system according to an embodiment.

FIG. 3 is a block diagram of an integrated purified water supply system according to an embodiment.

FIG. 4 is a flowchart showing a operation control of an integrated purified water supply system according to an embodiment.

FIG. 5 is a flowchart showing the operation control of an integrated purified water supply system according to another embodiment.

FIG. 6 is a table showing the order of priority for each home appliance.

FIG. 7 is a flowchart showing the operation control of an integrated purified water supply system according to still another embodiment.

### BEST MODE

The purposes, means and effects described above will be described in detail below with reference to the accompanying drawings, so that a person having ordinary knowledge in the technical field to which the present invention pertains can easily practice the technical idea of the present invention. In describing the present invention, if it is determined that a detailed description of a known technology related to the present invention may unnecessarily obscure the gist of the present invention, the detailed description thereof will be omitted. Hereinafter, preferred embodiments of the present invention will be described in detail with reference to the accompanying drawings. In the drawings, like reference symbols are used to refer to like or similar components.

Hereinafter, there are disclosed an integrated purified water supply system and a control method therefor, which are capable of supplying a sufficient amount of purified water to a plurality of home appliances that use water.

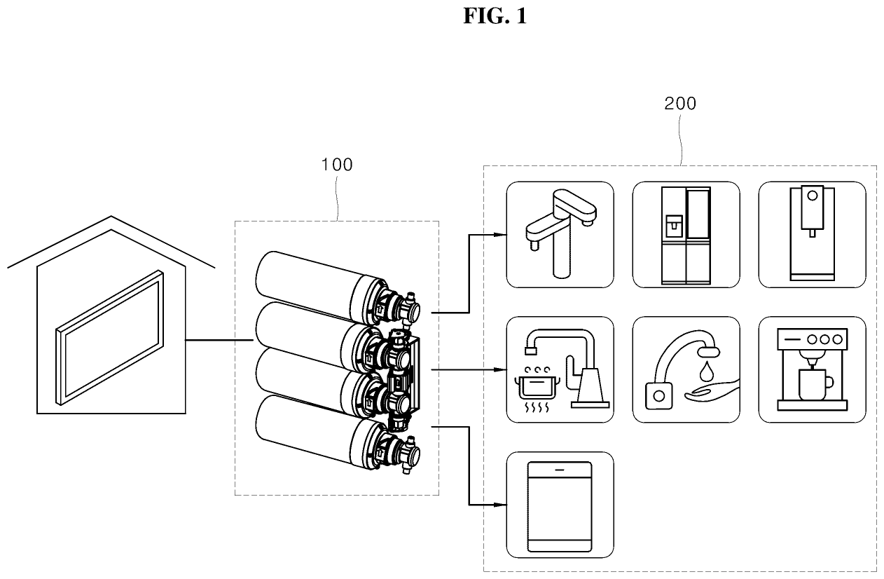

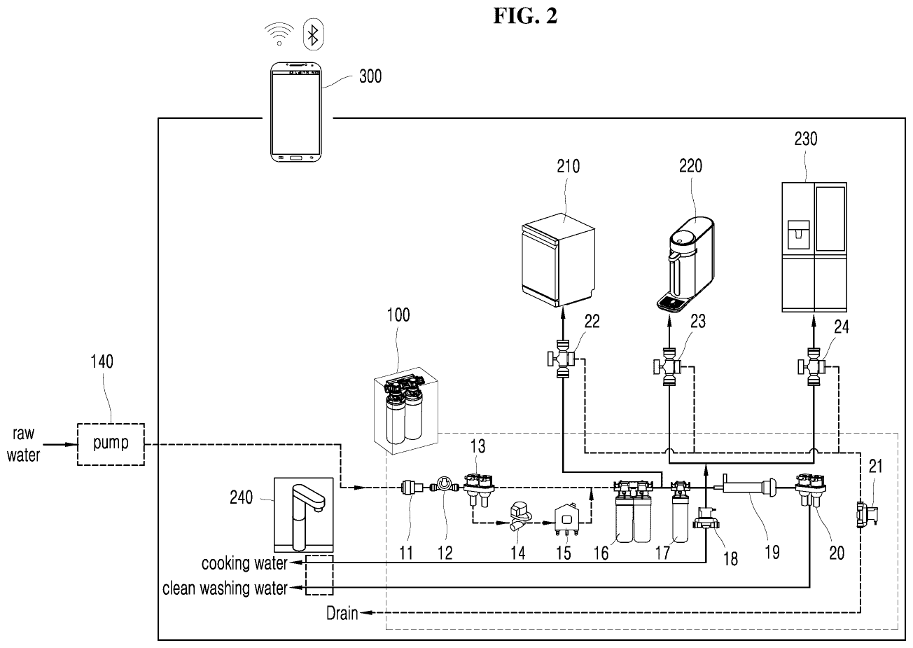

FIG. 1 is a conceptual diagram of an integrated purified water supply system according to an embodiment. FIG. 2 is a structural diagram of an integrated purified water supply system according to an embodiment.

An integrated purified water supply system according to an embodiment includes an integrated water purifier 100 and a plurality of home appliances 200.

The integrated water purifier 100 of the integrated purified water supply system purifies water and supplies it to the plurality of home appliances 200. The integrated water purifier 100 is connected to several home appliances 200 to supply purified water thereto all at once or separately.

The integrated purified water supply system is intended to efficiently supply clean and sufficient purified water to the water-using home appliances 200 through the single integrated water purifier 100.

The integrated water purifier 100 checks whether water is being used by performing communication with the plurality of home appliances 200 through a communication module, and controls the operation of a plurality of supply valves corresponding to the respective home appliances 200 to supply purified water at an output water amount predetermined for each home appliance 200.

The integrated water purifier 100 may supply drinking water, cooking and rinsing water, and washing water to the corresponding home appliance 200.

The introduced raw water passes through a pressure reducing valve 11, a flow sensor 12, a feed valve 13, and filters 16, 17 in the modular integrated water purifier 100, and is introduced to each home appliance 200 that requires water.

When the input of raw water supply for a water purifier, faucet, cooking water, refrigerator, dishwasher, coffee machine, beer maker, or the like is requested according to the user's request, clean purified water is discharged through each supply valve 18, 20, 22, 23, 24, and provided to the home appliance 200 selected by the consumer.

Additionally, it may be provided with a pump 140 to ensure normal operation of the product in low water pressure areas.

In FIG. 2, the integrated water purifier 100 further includes a flow control valve 14 and a heater 15, and the feed valve 13 may be operated as a sterilization valve that changes the flow path. The feed valve 13 may change the flow path to supply raw water through the flow control valve 14 and the heater 15. The control valve 14 and the heater 15 may be used to sterilize the flow path within the integrated water purifier 100.

The integrated water purifier 100 further includes an electrolyzed water module 19 and a sterilization drain valve 21. The electrolyzed water module 19 may supply cooking water or clean washing water to the home appliance 240 that requires it. The sterilization drain valve 21 is used to drain the water which has been used for flow path sterilization in the integrated water purifier 100.

Meanwhile, in terms of structure, the integrated water purifier 100 may include a machine room, a cooling part, a casing, a bottom plate, and a water outlet. The integrated water purifier 100 may have a function of filtering city water introduced from a water pipe, a function of cooling water to make it cold water, and a function of heating water to make it hot water.

The machine room may be provided in the lower side of the integrated water purifier 100, and various parts for operating the integrated water purifier 100 may be disposed therein. The cooler may be disposed in the upper side of the machine room, and cool water. In the cooler, there may be disposed an evaporator for cooling water. The water purifier may cool water with the use of a refrigeration cycle in which a phase-changing refrigerant circulates.

The refrigeration cycle may include a compressor, a condenser, an expander, and an evaporator, and be provided with piping, which connects each device to allow refrigerant to circulate through each device. The refrigerant, which acts as a working fluid in the refrigeration cycle, may be provided with various substances such as HCFC compounds, HFC compounds, and HFO compounds.

The gaseous refrigerant discharged from the evaporator may flow into the compressor, and the refrigerant may be compressed in the compressor, be discharged from the compressor in a high-temperature and high-pressure gaseous state, and then flow into the condenser.

As the refrigerant passes through the condenser, it condenses from a gaseous state to a liquid state while losing heat to the surroundings, and then it may be discharged from the condenser and introduced into the expander.

As the refrigerant passes through the expander, it expands adiabatically and some of it vaporizes, so it can reach a saturated state where gas and liquid are mixed with each other. The refrigerant loses heat of vaporization through adiabatic expansion, which can cause the temperature to drop rapidly. The saturated refrigerant discharged from the expander may be introduced into the evaporator.

As the refrigerant passes through the evaporator, it absorbs heat from the surroundings and vaporizes, and then it may be discharged from the evaporator in a state where almost all of it has been vaporized, and be introduced into the compressor.

While repeating the above-described cycle, the refrigerant can release heat to the surroundings in the condenser, and absorb heat from the surroundings in the evaporator. Thereby, the water can be cooled by removing heat from the water around the evaporator in the refrigeration cycle.

That is, in the cooler of the water purifier, heat exchange occurs between the evaporator and the cooling coil through which water flows, so that the refrigerant flowing through the evaporator can absorb heat and change its phase from liquid to gas, while the water flowing through the cooling coil can lose heat and be cooled.

And, the integrated water purifier 100 may include a filter for filtering city water introduced from a water pipe. The filter may be provided with, for example, a carbon block filter, a UF filter, or the like, and a plurality of filters may be provided in the water purifier.

Water which has passed through the filter may be discharged through a water outlet as it is, or be discharged through a water outlet after being cooled through a cooler, or be discharged through a water outlet after being heated through a heater.

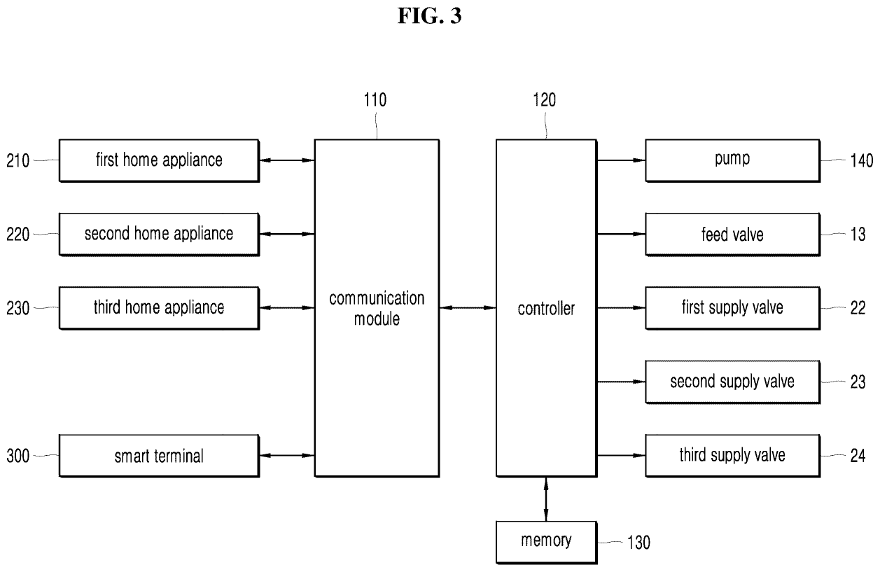

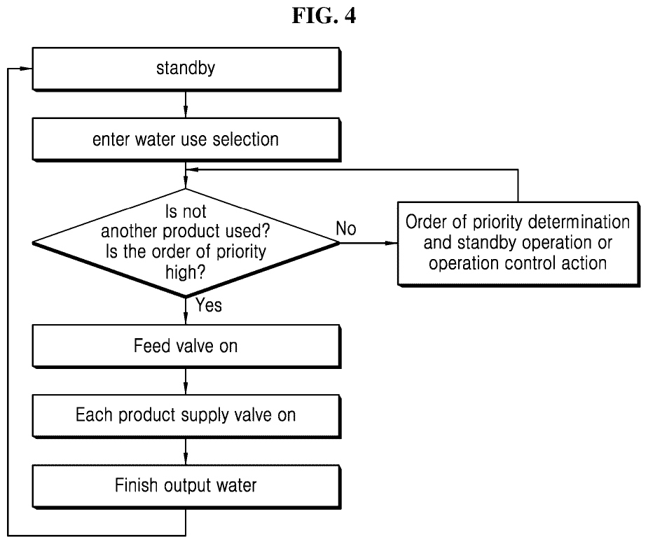

FIG. 3 is a block diagram of an integrated purified water supply system according to an embodiment. FIG. 4 is a flowchart showing a operation control of an integrated purified water supply system according to an embodiment.

Referring to FIGS. 3 and 4, an integrated water purifier supply system according to an embodiment includes a communication module 110, an integrated water purifier 100, a plurality of home appliances 210, 220, 230, 240, a plurality of supply valves 18, 20, 22, 23, 24, a pump 140, a memory 130, and a controller 120.

The communication module 110 communicates with the plurality of home appliances 210, 220, 230, 240.

The integrated water purifier 100 purifies raw water supplied through the feed valve 13 with the use of internal filters 16, 17.

The plurality of supply valves 18, 20, 22, 23, 24 allow water purified by the integrated water purifier 100 to be supplied to the plurality of home appliances 210, 220, 230, 240.

The pump 140 pumps raw water, and supplies it to the feed valve 13.

The memory 130 stores an order of priority among the plurality of home appliances 210, 220, 230, 240, and stores the output water amount reference values required by the plurality of home appliances 210, 220, 230, 240.

The controller 120 controls communication with the plurality of home appliances 210, 220, 230, 240 through the communication module 110, and controls the operation of the integrated water purifier 100.

When a water selection for the first home appliance 210 among the plurality of home appliances 210, 220, 230, 240 is entered into the controller 120, the controller determines whether other home appliances 220, 230, 240 are using water, and in the case where at least one of the other home appliances 220, 230, 240 is using water, the controller 120 determines an order of priority between the first home appliance 210 and the home appliance which is using water.

The controller 120 controls at least one of the feed valve 13, the first supply valve 22, and the second supply valve 23 so that purified water is supplied to at least one of the plurality of home appliances 210, 220, 230, 240 according to the order of priority.

The controller 120 controls at least one of the following according to the order of priority: standby operation of at least one of the plurality of home appliances 210, 220, 230, 240, turning-on operation of the feed valve 13, and turning-on operation of at least one of the plurality of supply valves 18, 20, 22, 23, 24. In addition, the controller 120 may turn on the pump 140 when the output water amount discharged to the plurality of home appliances 210, 220, 230, 240 is equal to or less than a reference value.

As an example, in the case where the order of priority of the first home appliance 210 into which water selection is entered is lower than that of the second home appliance 220 which is using water, the controller 120 controls the first home appliance 210 to perform the standby operation.

As an example, in the case where the order of priority of the first home appliance 210 is higher than that of the second home appliance 220 that is using water, the controller 120 controls the standby operation of the second home appliance 220, the turning-on operation of the feed valve 13, and the turning-on operation of the first supply valve 22 corresponding to the first home appliance 210.

As an example, in the case where the order of priority of the first home appliance 210 is such that its simultaneous operation with the second home appliance 220 which is using water is possible, the controller 120 controls the turning-on operation of the feed valve 13, and the turning-on operation of the first supply valve 22 and the second supply valve 23 corresponding to the first home appliance 210 and the second home appliance 220. Here, the controller 120 may control the standby operation and pause of the first home appliance 210 and the second home appliance 220 through the communication module 110.

The feed valve 13 allows raw water to be supplied into the integrated water purifier 100, and at least one or more filters 16, 17 filter the water supplied through the feed valve. The electrolyzed water module 19 electrolyzes water purified by at least one or more filters 16, 17 to produce ionized water.

A piping delivering the water purified by at least one or more filters 16, 17 is connected to at least one of the plurality of supply valves 18, 23, 24, and a piping delivering the water purified by the filter 16 is connected to the supply valve 22.

As an example, the plurality of supply valves 18, 23, 24 are connected to home appliances 220, 230, 240 that require water purified by the filters 16, 17, and the supply valve 22 is connected to the home appliance 210 that requires water purified by the filter 16.

The piping delivering the ionized water produced by the electrolyzed water module 19 is connected to the supply valve 20.

As an example, the supply valve 20 may be connected to the home appliance 240 that requires clean washing water.

The control method of the integrated purified water supply system configured in this manner is described as follows.

First, when the water selection for the first home appliance 210 is entered during the standby, the integrated water supply system determines whether other home appliance 220, 230, 240 is using water, and the order of priority between the first home appliance 210 and the second home appliance 220 in the case where the second home appliance 220 is using water.

Next, the integrated purified water supply system performs the turning-on operation of the feed valve 13, the first supply valve 22, and the second supply valve 22 in the case where the order of priority of the first home appliance 210 is higher than that of the second home appliance 220. At this time, the integrated purified water supply system can put the second home appliance 220 into the standby operation or pause through the communication module 110. When the first home appliance 210 has finished using water, the integrated water supply system may perform the turning-on operation for the second home appliance 220 which has been put into the standby operation.

Conversely, in the case where the order of priority of the first home appliance 210 is lower than that of the second home appliance 220, the integrated water supply system may control the first home appliance 210 to perform the standby operation, and it may perform the turning-on operation for the first home appliance 210 when the second home appliance 220 has finished using water.

In this regard, when the first home appliance 210 is put into the standby operation due to the use of water by the second home appliance 220, the integrated water supply system may control the display unit of the first home appliance 210 or the user's smart terminal 300 to display a notification enabling the user to perceive that the first home appliance 210 is in the state of the standby operation.

In this way, the modular home appliance integrated purified water supply system includes a microcomputer controller, so that it performs wired and wireless communication control with each home appliance, and, through the values, identifies the use states of other home appliances and the water supply valve control.

Once the water selection for each home appliance is entered, a signal is sent to the modular home appliance integrated purified water supply system, which then determines whether the water is being used by another home appliance. When not in use, the feed valve is turned on, and each product supply valve is turned on, so that clean water which has passed through the filter is supplied to the home appliance.

When being used in another product, the system may identify the order of priority assigned to each product to control the standby operation process or the process that absolutely requires simultaneous operation, and control the pump to operate in a manner that can supply an appropriate flow rate as needed.

Meanwhile, in the present embodiment, the controller 120 may accumulate the frequency of use of the first home appliance 210 and the second home appliance 220 for a specific period of time, and automatically set the order of priority based on the frequency of use. Additionally, at least one of the first home appliance 210 and the second home appliance 220 may further include an input part through which the order of priority is manually set according to the user's selection. Additionally, the order of priority may be set based on whether it is a drinking water or on the frequency of use. As an example, the order of priority may be set in the following order: water purifier including a faucet and cooking water, water purifier refrigerator, coffee machine, beer maker, and dishwasher, or may be set in the following order: water purifier, water purifier refrigerator, coffee machine, dishwasher, and beer maker.

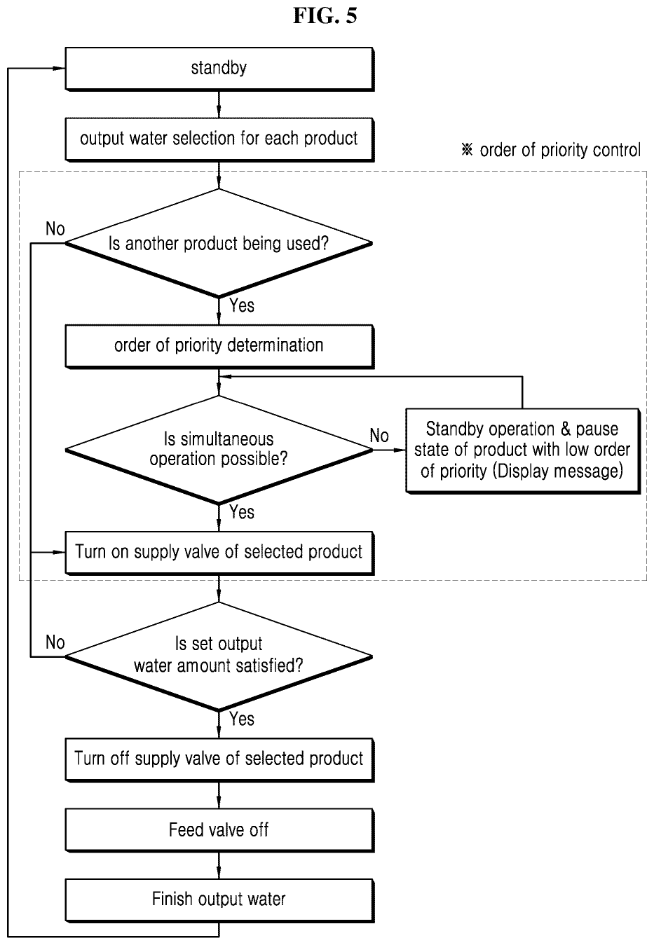

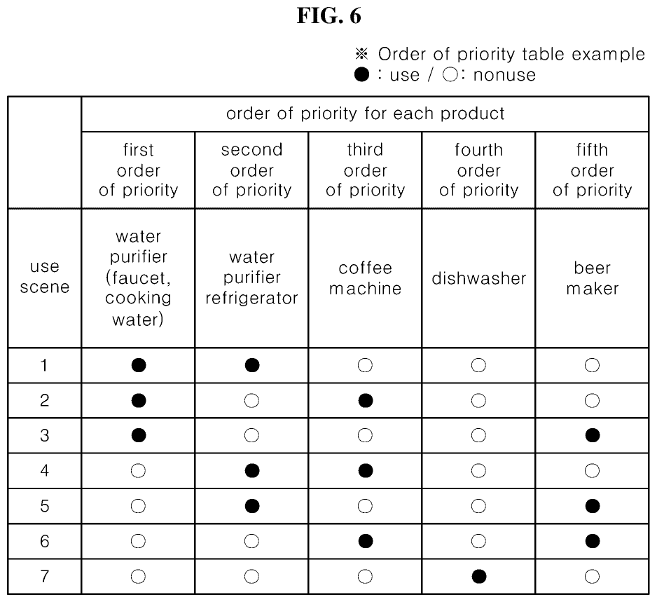

FIG. 5 is a flowchart showing the operation control of an integrated purified water supply system according to another embodiment. FIG. 6 is a table showing the order of priority for each home appliance.

Referring to FIGS. 3 and 5, when the water selection for the first home appliance 210 is entered during the standby, the integrated purified water supply system determines whether other home appliance 220, 230, 240 is using water.

Next, the integrated purified water supply system determines the order of priority among a plurality of home appliances 210, 220, 230, 240 which are using water.

As an example, the order of priority may be set in the following order based on the frequency of use: water purifier faucet, cooking water, water purifier refrigerator, coffee machine, dishwasher, and beer maker. Alternatively, the order of priority may be set in the following order based on whether it is a drinking water: water purifier, refrigerator, coffee machine, beer maker, dishwasher. Obviously, the present embodiment is not limited to this, but may be implemented in a modified form without departing from the technical concept of the present embodiment.

Next, the integrated water supply system determines whether simultaneous operation is possible. As an example, the integrated purified water supply system may determine that, when home appliances have the same order of priority, the same operation is possible. As another example, a setting value that enables simultaneous operation between home appliances may be preset, and it may be determined by that setting value that simultaneous operation is possible.

Next, when the simultaneous operation is not possible, the integrated purified water supply system may control a home appliance among the plurality of home appliances 210, 220, 230, 240, which has a lower order of priority, to perform the standby operation and pause, and to display a message regarding this.

Next, when the simultaneous operation is possible, the integrated water supply system performs the turning-on operation of the supply valves of the corresponding home appliances at the same time.

In this regard, the integrated water supply system may further check whether the set output water amount is satisfied. As an example, the integrated water supply system turns off the supply valve of the selected home appliance whose set output water amount has been satisfied.

Next, the integrated water supply system turns off the feed valve 130 to finish the output water.

In this way, the integrated water purification system is required to perform the operation of the order of priority when uses of the home appliances overlap with each other. This is because failure to satisfy the required flow rate may lead to errors in product operation or dissatisfactory operation performance of the product, thus causing inconvenience to consumers. Therefore, the home appliance which uses the most amount of water and uses water most frequently may be controlled to have the higher order of priority.

When observing the water use pattern in the integrated water purification system, the home appliances may be listed in the following order from greater to lesser frequency of use: water purifier faucet, cooking water>water purifier refrigerator>coffee machine>dishwasher>beer maker.

When the output water is selected entering the operation of each home appliance, it is determined whether another home appliance is used, and if so, the preset order of priority is looked up in order to determine whether simultaneous operation is possible. This can be verified and controlled by pre-verified data with regard to how many products can be reliably operated with a limited flow rate of the integrated water supply system.

If simultaneous operation is not possible due to exceeding the limited number of operable products, the product with a pre-selected lower order of priority will temporarily stop the operation to be put into standby, and at this time, send on the display a guidance message, that is, a content in use/standby message. Afterwards, the process proceeds as follows: when the operation of the home appliance with the highest order of priority is completed, the supply valve is turned off, and the operation of the home appliance which has been previously stopped is restarted in that order. When the set operations of all home appliances are completed, the modular home appliance integrated purified water supply system is controlled to stop, turning off the feed valve 13.

Referring to FIG. 6, the order of priority for each home appliance may be set such that home appliances are available simultaneously.

As an example, the order of priority for each home appliance may be set in the following order: water purifier faucet, cooking water, water purifier refrigerator, coffee machine, dishwasher, and beer maker.

As an example, it may be set such that a water purifier faucet, cooking water and a water purifier refrigerator are available simultaneously, it may be set such that a water purifier faucet, cooking water and a coffee machine are available simultaneously, and it may be set such that a water purifier faucet, cooking water and a beer maker are available simultaneously.

As an example, it may be set such that a water purifier refrigerator and a coffee machine are available simultaneously, it may be set such that a water purifier refrigerator and a beer maker are available simultaneously, and it may be set such that a coffee machine and a beer maker are available simultaneously.

As an example, it may be set such that a dishwasher is not available simultaneously with any home appliance.

As an example, if a request for water use from the water purifier is entered while the dishwasher is in operation, the dishwasher may be put into standby operation, and when the water use by the water purifier is completed, purified water may be supplied to the dishwasher again, making it operate.

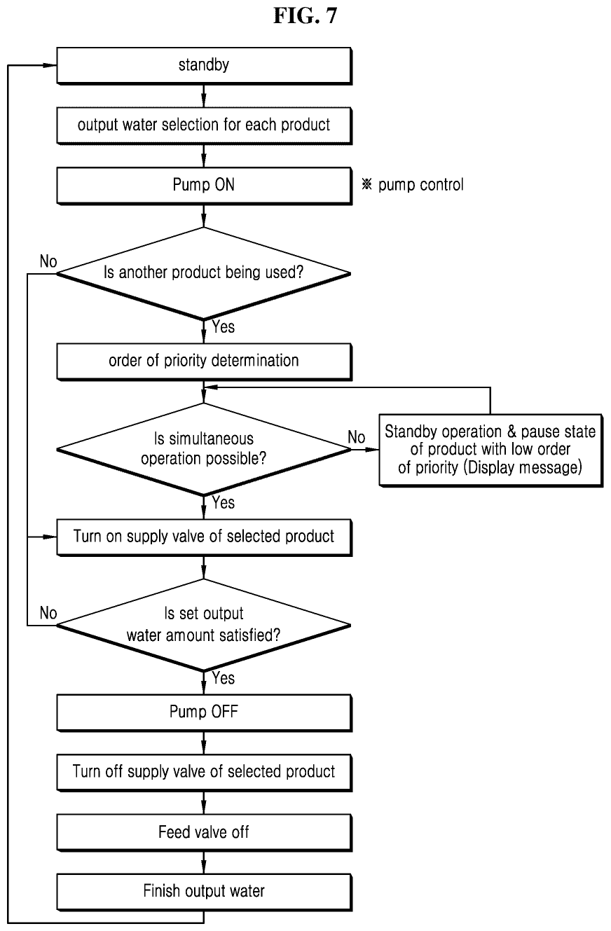

FIG. 7 is a flowchart showing the operation control of an integrated purified water supply system according to still another embodiment.

Referring to FIGS. 3 and 7, the integrated water supply system turns on the pump 140 when output water for each of the home appliance 200 including a water purifier, a faucet, a cooking water, a refrigerator, a dishwasher, a coffee machine, a beer maker, or the like is selected while the home appliance is in standby state.

Next, the integrated purified water supply system determines whether other appliances are in use.

Next, the integrated water supply system determines the order of priority when another appliance is using water.

Next, the integrated water supply system determines whether simultaneous operation is possible.

Next, when the simultaneous operation is not possible, the integrated purified water supply system controls a home appliance among the plurality of home appliances 210, 220, 230, 240, which has a lower order of priority, to perform the standby operation and pause, and to display a message regarding this.

Next, when the simultaneous operation is possible, the integrated water supply system performs the turning-on operation of the supply valves of the corresponding home appliances at the same time.

In this regard, the integrated water supply system further checks whether the set output water amount is satisfied.

When the set output water amount is satisfied, the integrated water supply system turns off the pump 140 operation.

Next, the integrated water supply system turns off the corresponding supply valve and the feed valve 130 to finish the output water.

As an example, when the order of priority of the first home appliance 210 for which output water is selected is higher than that of the second home appliance 220 which is using water and simultaneous operation is not possible, the integrated water supply system puts the second home appliance 220 into standby operation or pause, and turns on the first supply valve 22 corresponding to the first home appliance 210.

In this regard, when the first home appliance 210 has finished using water, the integrated water supply system performs the turning-on operation for the second home appliance 220 which has been into the standby operation. As an example, when water use is selected for a water purifier or coffee machine with a higher order of priority while a dishwasher with a lower order of priority is in operation, the use of the water purifier or coffee machine may be prioritized and the dishwasher may be put into pause, and then restarted when the use of the water purifier or coffee machine has been completed.

As an example, when the order of priority of the first home appliance 210 is lower than that of the second home appliance 220, the integrated water supply system may control the first home appliance 210 to perform the standby operation, and then perform the turning-on operation for the first home appliance 210 when the water use of the second home appliance 220 has been completed.

As an example, when there is a water selection for a dishwasher with a lower order of priority while the water purifier is in operation, the dishwasher may be put into the standby operation, and water may be supplied to the dishwasher, making it operate, after the operation of the water purifier has been completed.

As described above, with the added pump, the simultaneous operation of home appliances can be controlled. In this case, each household may have different raw water pressures when initially installing a home appliance, and especially in areas with low water pressure, simultaneous use of home appliances may affect the operation of other products. At this time, a separate pump may be installed and operated in front of the modular home appliance integrated purified water supply system, and be controlled to satisfy a certain level of the flow rate of raw water.

In this manner, according to the present embodiments, the order of priority and possibility for simultaneous operation between home appliances are set for each home appliance, and the operation order of home appliances is controlled according to the order of priority and the possibility for simultaneous operation between home appliances. Additionally, according to the present embodiments, the pump may be turned on to satisfy the output water amount required by the respective home appliances.

The integrated purified water supply system according to an embodiment includes a communication module 110 communicating with a first home appliance and a second home appliance, an integrated water purifier 100 purifying raw water supplied through a feed valve 13, a first supply valve 22 and a second supply valve 23 allowing water purified by the integrated water purifier 100 to be supplied to the first home appliance 210 and the second home appliance 220, and a controller 120 controlling the communication with the first home appliance 210 and the second home appliance 220 through the communication module 110 and controlling the operation of the integrated water purifier 100.

The controller 120 accumulates the frequency of use of the first home appliance 210 and the second home appliance 220 for a specific period of time, and automatically sets the order of priority based on the frequency of use.

At least one of the first home appliance 210 and the second home appliance 220 further includes an input part through which the order of priority is manually set according to the user's selection.

As an example, the order of priority is set based on whether it is a drinking water or on the frequency of use. The order of priority may be set in the following order: water purifier including a faucet and cooking water, water purifier refrigerator, coffee machine, beer maker, and dishwasher.

When the water selection for the first home appliance 210 is entered, the controller 120 determines whether the second home appliance 220 is using water, and determines the order of priority between the first home appliance 210 and the second home appliance 220 in the case where the second home appliance 220 is using water.

The controller 120 controls at least one of the feed valve 13, the first supply valve 22, and the second supply valve 23 so that purified water is supplied to at least one of the first home appliance 210 and the second home appliance 220 according to the order of priority.

The controller 120 controls at least one of the following according to the order of priority: standby operation of at least one of the first home appliance 210 and the second home appliance 220, turning-on operation of the feed valve 13, and turning-on operation of at least one of the first supply valve 22 and the second supply valve 23.

The integrated water supply system further includes a pump 140 pumping raw water and supplying it to the feed valve 13.

The integrated purified water supply system further includes a flow sensor sensing the output water amount of the integrated water purifier 100.

The controller 120 turns on the pump 140 when the output water amount sensed by the flow sensor is equal to or less than the reference value.

In the case where the order of priority of the first home appliance 210 is lower than that of the second home appliance 220 which is using water, the controller 120 controls the first home appliance 210 to perform the standby operation.

In the case where the order of priority of the first home appliance 210 is higher than that of the second home appliance 220 that is using water, the controller 120 controls the standby operation of the second home appliance 220, the turning-on operation of the feed valve 13, and the turning-on operation of the first supply valve 22.

In the case where the order of priority of the first home appliance 210 is such that its simultaneous operation with the second home appliance 220 which is using water is possible, the controller 120 controls the turning-on operation of the feed valve 13, and the turning-on operation of the first supply valve 22 and the second supply valve 23.

The integrated water supply system further includes the memory 130 storing an order of priority between the first home appliance 210 and the second home appliance 220, and the output water amount reference values required by the first home appliance 210 and the second home appliance 220.

The integrated purified water supply system includes the communication module 110 communicating with the first home appliance 210 and the second home appliance 220, and the controller 120 controls the operation standby, pause, and operation of the first home appliance 210 and the second home appliance 220 through the communication module 110.

The integrated water purifier 100 includes the feed valve 13 through which raw water is supplied, at least one or more filters 16, 17 filtering the water supplied through the feed valve, and the electrolyzed water module 19 electrolyzing the water purified by at least one or more filters 16, 17 to produce ionized water.

The piping delivering the water purified by at least one or more filters 16, 17 and the piping delivering the ionized water produced by the electrolyzed water module 19 are connected to at least one of the first supply valve 22 and the second supply valve 23.

According to one embodiment, a control method for an integrated purified water supply system including a communication module 110 communicating with a first home appliance and a second home appliance, an integrated water purifier 100 purifying raw water supplied through a feed valve 13, a first supply valve 22 and a second supply valve 23 allowing water purified by the integrated water purifier 100 to be supplied to the first home appliance 210 and the second home appliance 220, and a controller 120 controlling the communication with the first home appliance 210 and the second home appliance 220 through the communication module 110 and controlling the operation of the integrated water purifier 100 includes determining whether the second home appliance 220 is using water when water selection for the first home appliance 210 is entered, and determining an order of priority between the first home appliance 210 and the second home appliance 220 in a case where the second home appliance 220 is using water.

The control method for an integrated purified water supply system further includes controlling at least one of the feed valve 13, the first supply valve 22, and the second supply valve 22 so that purified water is supplied to at least one of the first home appliance 210 and the second home appliance 220 according to the order of priority.

The control method for an integrated purified water supply system further includes controlling at least one of the following according to the order of priority: standby operation of at least one of the first home appliance 210 and the second home appliance 220, turning-on operation of the feed valve 13, and turning-on operation of at least one of the first supply valve 22 and the second supply valve 23.

According to the control method for an integrated water purifier supply system further including a pump 140 pumping raw water and supplying it to the feed valve 13, and a flow sensor sensing the output water amount of the integrated water purifier 100, the pump 140 is turned on when the output water amount sensed by the flow sensor is equal to or less than a reference value.

The control method for an integrated purified water supply system further includes controlling the first home appliance 210 to perform the standby operation when the order of priority of the first home appliance 210 is lower than that of the second home appliance 220.

The control method for an integrated purified water supply system further includes controlling the standby operation of the second home appliance 220, the turning-on operation of the feed valve 13, and the turning-on operation of the first supply valve 22.

The control method for an integrated purified water supply system further includes turning on the feed valve 13, the first supply valve 22, and the second supply valve 23 in the case where the order of priority of the first home appliance 210 is such that its simultaneous operation with the second home appliance 220 which is using water is possible.

The control method for an integrated purified water supply system further includes operating the pump 140 pumping raw water in the case where the output water amount of the integrated water purifier 100 is lower than the output water amount reference value required by the first home appliance 210 and the second home appliance 220.

As described above, the integrated purified water supply system and the control method therefor according to an embodiment can supply a sufficient amount of purified water to a plurality of water-using home appliances.

Additionally, by controlling at least one of the standby operation, pause, and simultaneous operation depending on whether another home appliance is used, and on the order of priority, a sufficient amount of purified water can be supplied to each home appliance.

Additionally, by controlling at least one or more of the respective supply valves of the home appliances and the pump operation, a sufficient amount of purified water required by each home appliance can be supplied.

Additionally, through a single integrated water purifier, it is possible to provide a stable supply of purified water to all water-using home appliances.

Additionally, it is possible to supply purified water efficiently to each home appliance according to the set separate order of priority.

Additionally, it is possible to supply purified water at an output water amount required by each home appliance.

Additionally, it is possible to increase consumer convenience and satisfaction by controlling a single integrated water purifier according to the order of priority to efficiently supply a sufficient amount of purified water to other home appliances which use water at the same time.

Although the present invention has been described with reference to the illustrative drawings as the above, the present invention is not limited to the embodiments and drawings disclosed in this specification, and it is obvious that various modifications can be made by those skilled in the art without departing from the scope of the technical idea of the present invention. Additionally, even if the effects related to the configuration of the present invention were not explicitly described while explaining the embodiments of the present invention, it is obvious that the effects predictable from the configuration should also be acknowledged.

1. An integrated purified water supply system comprising:
an integrated water purifier purifying raw water;
a first supply valve and a second supply valve, both the supply valves allowing water purified by the integrated water purifier to be supplied to a first home appliance and a second home appliance; and
a controller controlling communication with the first home appliance and the second home appliance, and controlling an operation of the integrated water purifier,
wherein when a water selection for the first home appliance is entered, the controller determines whether the second home appliance is using water, and, in a case where the second home appliance is using water, the controller determines an order of priority between the first home appliance and the second home appliance.

2. The integrated purified water supply system of claim 1, wherein the controller accumulates a frequency of use of the first home appliance and the second home appliance for a specific period of time, and automatically sets the order of priority based on the frequency of use.

3. The integrated purified water supply system of claim 2, wherein at least one of the first home appliance and the second home appliance further includes an input part through which the order of priority is manually set according to user's selection.

4. The integrated purified water supply system of claim 1, wherein the order of priority is set based on whether it is a drinking water or on a frequency of use.

5. The integrated purified water supply system of claim 4, wherein the order of priority is set in the following order: water purifier including a faucet and cooking water, water purifier refrigerator, coffee machine, beer maker, and dishwasher.

6. The integrated purified water supply system of claim 1, wherein the controller controls at least one of a feed valve allowing raw water to be supplied to the integrated water purifier, the first supply valve, and the second supply valve so that purified water is supplied to at least one of the first home appliance and the second home appliance according to the order of priority.

7. The integrated purified water supply system of claim 1, a pump pumping raw water and supplying it to the integrated water purifier; and
a flow sensor sensing an output water amount supplied from the integrated water purifier to the first home appliance and the second home appliance, further comprising:
wherein the controller turns on the pump when the output water amount sensed by the flow sensor is equal to or less than a reference value.

8. The integrated purified water supply system of claim 1, wherein the controller
controls the first home appliance to perform a standby operation in a case where the order of priority of the first home appliance is lower than that of the second home appliance which is using water, and
controls a standby operation of the second home appliance and a turning-on operation of the first supply valve in a case where the order of priority of the first home appliance is higher than that of the second home appliance.

9. The integrated purified water supply system of claim 1, wherein in a case where the order of priority of the first home appliance is such that its simultaneous operation with the second home appliance which is using water is possible, the controller controls a turning-on operation of the feed valve, and a turning-on operation of the first supply valve and the second supply valve.

10. The integrated purified water supply system of claim 1, further comprising:
a memory storing an order of priority between the first home appliance and the second home appliance, output water amount reference values required by the first home appliance and the second home appliance, and data on whether simultaneous operation is possible between the first home appliance and the second home appliance.

11. The integrated purified water supply system of claim 1, further comprising:
a communication module communicating with the first home appliance and the second home appliance,
wherein the controller controls a standby operation, a pause, and an operation of the first home appliance and the second home appliance through the communication module.

12. The integrated purified water supply system of claim 1, wherein the integrated water purifier includes:
a feed valve allowing raw water to be supplied to the integrated water purifier according to control by the controller;
at least one or more filters filtering the water supplied through the feed valve; and
an electrolyzed water module electrolyzing the water purified by said at least one or more filters to produce ionized water.

13. The integrated purified water supply system of claim 12, wherein a piping delivering the water purified by said at least one or more filters and a piping delivering the ionized water produced by the electrolyzed water module are connected to at least one of the first supply valve and the second supply valve.

14. A control method for an integrated purified water supply system including an integrated water purifier purifying raw water, a first supply valve and a second supply valve, both the supply valves allowing the water purified by the integrated water purifier to be supplied to the first home appliance and the second home appliance, and a controller controlling communication with the first home appliance and the second home appliance, and controlling an operation of the integrated water purifier, the control method comprising:
determining whether the second home appliance is using water, when a water selection for the first home appliance is entered; and
determining an order of priority between the first home appliance and the second home appliance in a case where the second home appliance is using water.

15. The control method for an integrated purified water supply system of claim 14, further comprising:
accumulating a frequency of use of the first home appliance and the second home appliance for a specific period of time, and automatically setting the order of priority based on the frequency of use.

16. The control method for an integrated purified water supply system of claim 15, further comprising:
manually setting the order of priority according to user's selection through an input part included in at least one of the first home appliance and the second home appliance.

17. The control method for an integrated purified water supply system of claim 14, further comprising:
controlling at least one of a feed valve, the first supply valve, and the second supply valve so that purified water is supplied to at least one of the first home appliance and the second home appliance according to the order of priority.

18. The control method for an integrated purified water supply system of claim 14, wherein the integrated water purifier supply system further includes a pump pumping raw water and supplying it to the integrated water purifier, and a flow sensor sensing an output water amount of the integrated water purifier, the control method further comprising turning on the pump when the output water amount sensed by the flow sensor is equal to or less than a reference value.

19. The control method for an integrated purified water supply system of claim 14, further comprising:
in a case where the order of priority of the first home appliance is such that its simultaneous operation with the second home appliance which is using water is possible, performing a turning-on operation of a feed valve, the first supply valve and the second supply valve.

20. The control method for an integrated purified water supply system of claim 19, further comprising:
additionally operating a pump pumping raw water and supplying it to the integrated water purifier in a case where an output water amount of the integrated water purifier is lower than an output water amount reference value required by the first home appliance and the second home appliance when purified water is supplied simultaneously to the first home appliance and the second home appliance.
